(19) United States
(12) Patent Application Publication
(10) Pub. No.: US 2022/0348714 A1
(43) Pub. Date: Nov. 3, 2022

(54) BENDING-RESISTANT POLYESTER FILM AND THE PRODUCTION METHOD THEREOF

(71) Applicant: SHINKONG SYNTHETIC FIBERS CORPORATION, Taipei City (TW)

(72) Inventors: Kou Tai TZOU, Taoyuan City (TW); Jeffrey WU, Miaoli County (TW); Po Sheng HUANG, Taoyuan City (TW); Hou Yi YANG, Taoyuan City (TW)

(73) Assignee: SHINKONG SYNTHETIC FIBERS CORPORATION, Taipei City (TW)

(21) Appl. No.: 17/725,557

(22) Filed: Apr. 21, 2022

Related U.S. Application Data
(60) Provisional application No. 63/178,550, filed on Apr. 23, 2021.

(51) Int. Cl. C08G 63/91

(52) U.S. Cl. CPC C08G 63/916

(57) ABSTRACT

The present application discloses a bending-resistant polyester film and its production method thereof. The chemical structure of the bending-resistant polyester composition comprises monomers having elastic conformation. The film made from the composition of polyester of the present invention through production processes such as melt extrusion and biaxial drawing still has excellent flexibility and optical properties.

### CROSS-REFERENCE TO RELATED APPLICATIONS

This application claims the benefit of priority of U.S. Provisional Application No. 63/178,550, filed on Apr. 23, 2021.

### FIELD OF THE INVENTION

The present invention relates to a polyester film which may be applied in flexible display panels.

### BACKGROUND OF THE INVENTION

Typically, a traditional display panel is made from rigid materials, and the scope of its application includes monitors, mobile phones, televisions, tablet computers, etc. With the progress and development of technology, flexible display panels have started to appear in the market. The flexible display panels have more application possibilities and may be used in car interiors or various decorations, and the storage space is also reduced. Furthermore, the display panels having flexibility can also be adjusted to the most comfortable viewing angle to meet different user's field of vision, which will provide more convenience for applications in life.

WO2016021746A1 and U.S. Pat. No. 9,061,474B2 describe technology of colorless polyimide (PI) which is a good material applicable for use in flexible panels. The colorless polyimide has good flexibility, tearing strength, heat resistance and chemical resistance, and the physical properties thereof are very suitable for use in flexible panels. As compared with common polyimide, the colorless polyimide has showed a significant improvement on color hue. However, the colorless polyimide still has a defect of yellowish color as compared with polyester (PET). Moreover, due to the high cost of the colorless polyimide, the popularity of its use in the protective window of flexible display panels is therefore limited.

Considering the cost and the optical properties, PET has become another material used in the protective window of flexible display panels. Generally, PET has a very competitive price and good transparency as well as color, and has been widely used in the field of optical films. The technologies of polyester films disclosed in patent applications TW201833198A and TW201842006A are directed to an application of PET to the protective window of flexible panels. Nevertheless, although PET has good optical properties and is low cost, the bending resistance thereof is not good. After polyester is used on a flexible panel for a certain period of time, and with as the number of bending times increases, the bending marks will gradually appear on the PET film, which affect not only the aesthetics but also the clarity of the user's view.

### SUMMARY OF THE INVENTION

The present invention relates to a polyester film with good optical properties and excellent bending resistance, which is capable of being bent many times over a long period of time without causing bending marks.

The present invention relates to a polyester composition with a chemical structure wherein an elastic three-dimensional conformation is introduced thereto, such that the polyester has better bending resistance and resilience and therefore, is capable of withstanding a higher number of bending times without causing damage to its appearance.

The present invention relates to a process for producing a polyester composition, and the polyester composition obtained therefrom can be further produced into a film with bending resistance.

The polyester composition of the present invention comprises repeating monomers, including at least one polybasic acid and at least one diol, and at least one modifying monomer having the following general formula (1):

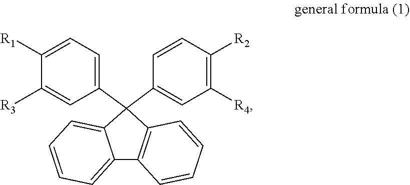

wherein R₁ and R₂ can independently be a reactive functional group such as an amino group, a hydroxyl C₁₋₈ alkoxy group or a hydroxyl group. Preferably, R₁ and R₂ are independently an amino group, a hydroxyl group or a hydroxyethoxy group. R₃ and R₄ can independently be a hydrogen atom or an aliphatic functional group such as a C₁₋₈ alkyl group. Preferably, R₃ and R₄ are independently a hydrogen atom, a methyl group or an ethyl group.

In preferred embodiments of the present invention, a glass transition temperature (Tg) of the polyester composition of the present invention is from 75 to 95° C., and a melting point (Tm) is from 230 to 255° C.

In preferred embodiments of the present invention, the compound of formula (1) as the modifying monomer is selected from the group consisting of:

R₁ and R₂ are a hydroxyethoxy group, and R₃ and R₄ are a hydrogen atom. The compound is 9,9-Bis[4-(2-hydroxyethoxy)phenyl]fluorene/Bisphenoxy ethanol fluorine (BPEF), as shown in the following structural formula (I):

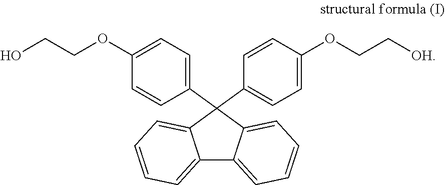 [SMILES: OCCOc1ccc(C2(c3ccc(OCCO)cc3)c3ccccc3-c3ccccc32)cc1]

R₁ and R₂ are a hydroxyl group, and R₃ and R₄ are a hydrogen atom. The compound is 9,9-bis(4-hydroxyphenyl)fluorine/Bisphenol fluorene (BPF), as shown in the following structural formula (II):

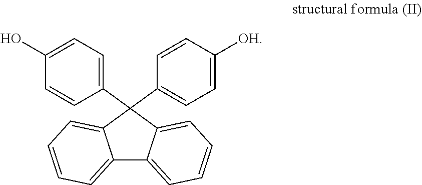 [SMILES: Oc1ccc(C2(c3ccc(O)cc3)c3ccccc3-c3ccccc32)cc1]

R₁ and R₂ are a hydroxyl group, and R₃ and R₄ are a methyl group. The compound is 9,9-Bis(4-hydroxy-3-methylphenyl)fluorine/Biscresol fluorene (BCF), as shown in the following structural formula (III):

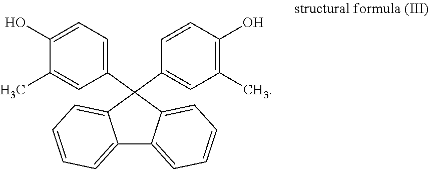 [SMILES: Cc1cc(C2(c3ccc(O)c(C)c3)c3ccccc3-c3ccccc32)ccc1O]

R₁ and R₂ are an amino group, and R₃ and R₄ are a hydrogen atom. The compound is 9,9-Bis(4-aminophenyl)fluorene/Bisaniline fluorene (BAF), as shown in the following structural formula (IV):

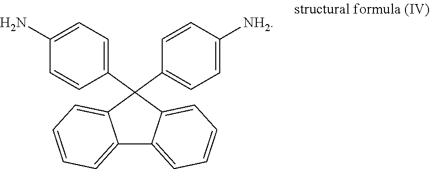 [SMILES: Nc1ccc(C2(c3ccc(N)cc3)c3ccccc3-c3ccccc32)cc1]

In addition to the modifying monomer having an elastic three-dimensional conformation as shown in the above structural formulas (I) to (IV), a precursor for esterification of BPEF, BPF, BCF, BAF and other modifying monomers can be applied to the present invention. The precursor for esterification mentioned in the present invention refers to an intermediate formed with molecular weight <1000, which is formed by the reaction monomers before the esterification reaction is complete. The intermediate can form an ester with more than 95% esterification ratio after further esterification reaction or transesterification reaction. The ester can be polymerized under appropriate conditions to form a polyester.

In preferred embodiments of the present invention, the modifying monomer having the structure of formula (1) is present in an amount of 0.1 to 10 mol %, more preferably 0.5 to 7.5 mol %, based on the total amount of polybasic acids of the polyester. Alternatively, the modifying monomer having the structure of formula (1) is present in an amount of about 0.1-10 mol %, preferably about 0.5 to 7.5 mol %, based on the total amount of diols of the polyester.

In preferred embodiments of the present invention, the polybasic acids for producing the polyester composition of the present invention include but not limited to aliphatic dicarboxylic acids, aromatic dicarboxylic acids, polyfunctional carboxylic acids or precursors for esterification thereof. The aliphatic dicarboxylic acids include but not limited to succinic acid, glutaric acid, adipic acid, a pimelic acid, a suberic acid, an azelaic acid, a sebacic acid or 1,4-cyclohexanedicarboxylic acid. The aromatic dicarboxylic acids include but not limited to terephthalic acid, isophthalic acid, or 2,6-naphthalenedicarboxylic acid. The polyfunctional carboxylic acids include but not limited to 1,2,4-benzenetricarboxylic acid or 1,2,4,5-pyromellitic acid. Alternatively, the polybasic acids for producing the polyester composition of the present invention could also be esters of the various polybasic acids mentioned above.

In preferred embodiments of the present invention, the diols for producing the polyester of the present invention include but not limited to aliphatic diols or precursors for esterification thereof, such as ethylene glycol, diethylene glycol, a 1,3 propylene glycol, 1,4-butanediol, neopentyl glycol, 1,4-cyclohexanedimethanol, etc. Alternatively, said diols can be high molecular weight aliphatic polyols such as polyethylene glycol or polytetramethylene ether glycol having molecular weights ranging from about 150 to about 20,000 g/mol. The molecular weight in the present invention may be a number-average molecular weight, mass-average molecular weight or viscosity-average molecular weight, and preference is made to a mass-average molecular weight.

In preferred embodiments of the present invention, the polyester composition of the present invention has a structural formula (V):

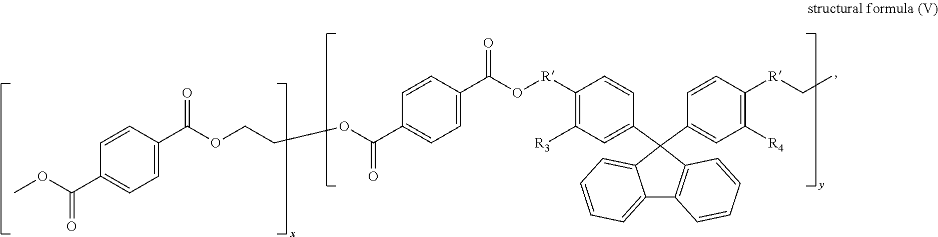

wherein R′ is O, NH or OC₂H₄, and x+y=1, x=0.9 to 0.999, y=0.001 to 0.1, and R₃ and R₄ have the aforementioned definitions.

In addition, the present invention provides a polyester sheet comprising said polyester composition.

In preferred embodiments of the present invention, said polyester sheet may be manufactured after being melt and extruded by an extruder at a temperature ranging from about 230 to about 300° C., and the thickness of said polyester sheet is preferably about 200 to about 800 μm.

In addition, the present invention provides a polyester film comprising said polyester composition, such as a polyester film made from said polyester sheet, and the thickness of said polyester film is preferably about 20 to about 200 μm. Preferably, said polyester sheet may be manufactured into a bending-resistant polyester film with a thickness of about 20 to about 200 μm through biaxial drawing which extends said polyester sheet about 1.5-fold to 5-fold in length along the transverse direction (TD, the direction perpendicular to the extrusion direction of the polyester sheet) and about 1.5-fold to 5-fold in length along the machine direction (MD, the extrusion direction of the polyester sheet). The machine direction is the long-axis direction of the sheet, and the transverse direction is the short-axis direction of the sheet.

In preferred embodiments of the present invention, the polyester film may comprise a hard coating on the surface of the polyester film. The hard coating may have a transmittance equal or more than 90%, a haze equal or less than 2%, and a hardness more than 1H (1 kg load) measured in accordance with ASTM D1003.

In preferred embodiments of the present invention, the hard coating of the polyester film may have a pencil hardness of up to 3H (500 g load) or have a pencil hardness of up to 1H (1 kg load) measured in accordance with JIS K5600-5-4:1999.

In preferred embodiments of the present invention, said polyester film can be bent for 100,000 to 300,000 times with a bending radius of 0.5 to 3 mm without appearance of bending marks. This hard coating primarily protects the bending-resistant polyester film from scratches or abrasions.

In addition, the present invention provides a process for producing polyester film, of which the steps comprise: 1) extruding said polyester composition into the polyester sheet at a temperature ranging from about 230 to about 300° C., 2) manufacturing the polyester sheet into the polyester film through biaxial drawing, 3) coating a hard coating on the surface of the polyester film.

In preferred embodiments of the present invention, said biaxial drawing is to extend the polyester sheet 1.5-fold to 5-fold in length along a short-axis direction and a long-axis direction of the polyester sheet, wherein the short-axis direction and the long-axis direction are substantially perpendicular to each other.

### DETAILED DESCRIPTION OF THE INVENTION

Other aspects of the embodiments of the present invention will be described in more detail below. It should be understood that the present invention may be embodied in different forms and should not be construed as limited to the embodiments described in the present invention. In contrast, the embodiments of the present invention are provided for fuller and more complete disclosure of the present invention, and enable the person having ordinary skill in the art to understand and carry out the present invention.

Unless otherwise illustrated, all technologies and scientific terms used herein have the same meaning as general understanding of the person having ordinary skill in the art. When a specific value is mentioned, a variation of not more than 1% from the specific value is also included. For example, when referring to a value “100”, it also includes 99 and 101 and all rational and irrational numbers in between, such as 99.1, 99.2, 99.321, 99.45, 99.8789, etc.

### Polyester Composition

Some embodiments of the present invention specify a polyester composition, which comprises repeating monomers polymerized from polybasic acids and diols, and a modifying monomer having an elastic three-dimensional conformation, and the structure is shown as following general formula (1):

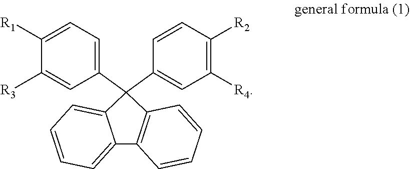

In the above general formula (1), R₁ and R₂ are independently an amino group, a hydroxyl group, or a hydroxyl C1-8 alkoxy group (—OCₙH₂ₙ—OH, n=1, 2, 3, 4, 5, 6, 7 or 8), such as a hydroxymethoxy group, a hydroxyethoxy group, a hydroxy-n-propoxy group, a hydroxyisopropoxy group, a hydroxy-n-butoxy group, a hydroxyisobutoxy group, a hydroxy butoxy group, a hydroxy-3-butoxy group, a hydroxyring Butoxy group, a hydroxy-n-pentyloxy group, a hydroxyisoamyloxy group, a hydroxyneopentyloxy group, a hydroxycyclopentyloxy group, a hydroxyter-pentyloxy group, a hydroxymethylbutoxy group, a hydroxymethylpropoxy group, a hydroxybutylpropoxy group, a hydroxy-n-hexyloxy group, a hydroxyisohexyloxy group, a hydroxycyclohexyloxy group, a hydroxy-n-heptyloxy group, a hydroxyisoheptyloxy group, a hydroxy-n-octyloxy or a hydroxyiso-octyloxy group. Preferably, R₁ and R₂ are independently an amino group, a hydroxyl group or a hydroxyethoxy group. In addition, R₃ and R₄ are independently a hydrogen atom or a C1-8 alkyl group, such as a methyl group, an ethyl group, a n-propyl group, an isopropyl group, a n-butyl group, a 2-methylpropyl (isobutyl) group, a secondary butyl group, a tertiary butyl group, a cyclobutyl group, a n-pentyl group, an isopentyl group, a secondary pentyl group, a tertiary pentyl group, a neopentyl group, a 2-methylbutyl group, a 1,2-dimethylpropyl group, a 1-ethylpropyl group, a cyclopentyl group, a n-hexyl group, an isohexyl group, a secondary hexyl group, a tertiary hexyl group, a neohexyl group, a 2-methylpentyl group, a 1,2-dimethylbutyl group, a 2,3-dimethylbutyl group, a 1-ethylbutyl group, a cyclohexyl group, a n-heptyl group, an isoheptyl group, a secondary heptyl group, a tertiary heptyl group, a neoheptyl group, a cycloheptyl group, a n-octyl group, an isooctyl group, a secondary octyl group, a tertiary octyl group, a neooctyl group, a 2-ethylhexyl group or a cyclooctyl group. Preferably, R₃ and R₄ are independently a hydrogen atom, a methyl group or an ethyl group. In preferred embodiments of the present invention, a glass transition temperature (Tg) of the polyester composition of the present invention is from 75 to 95° C., and a melting (Tm) is from 230 to 255° C. In preferred embodiments of the present invention, the repeating monomers polymerized of the polyesters from polybasic acids and diols are present in an amount of 90.0 to 99.9 mol %.

In addition, in preferred embodiments of the present invention, R₁ and R₂ in the above-mentioned general formula (1) are independently an amino group, a hydroxyl group or a hydroxyethoxy group, and R₃ and R₄ are independently a hydrogen atom, a methyl group or an ethyl group.

For example, in the polyester composition of the embodiments, the modifying monomer may be 9,9-Bis[4-(2-hydroxyethoxy)phenyl]fluorene (BPEF), 9,9-bis(4-hydroxyphenyl)fluorine (BPF), 9,9-Bis(4-hydroxy-3-methylphenyl)fluorine (BCF), 9,9-Bis(4-aminophenyl)fluorine (BAF) as shown in the following structural formulas (I) to (IV) or the precursor for esterification thereof. Since the modifying monomer has an elastic three-dimensional conformation, it has better bending resistance and resilience when being bent.

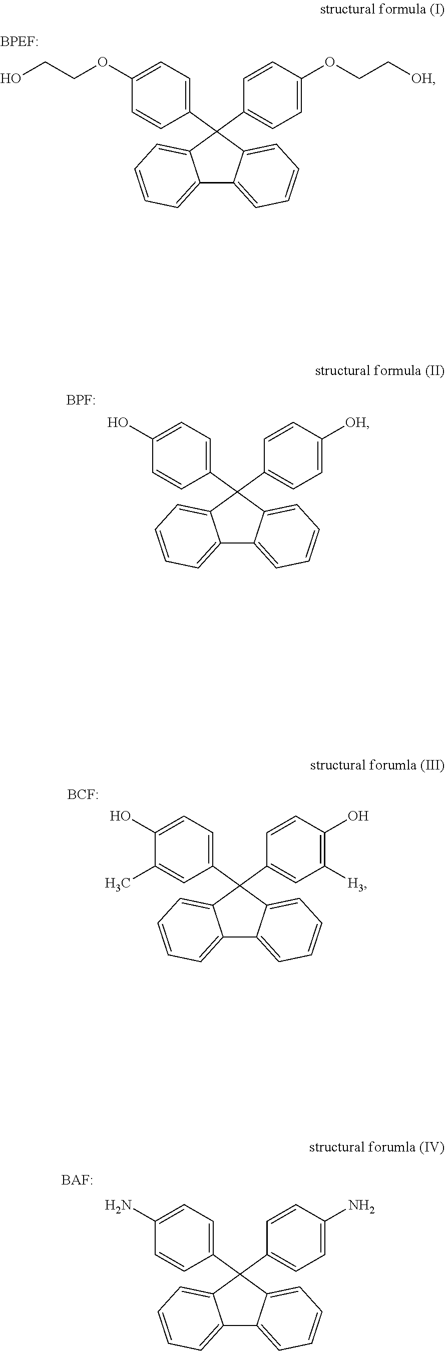

In preferred embodiments of the present invention, the modifying monomer of the polyester composition is present in an amount of 0.1 to 10 mol % based on the total amount of polybasic acids or diols of the polyester, such as 0.1 mol %, 0.2 mol %, 0.3 mol %, 0.4 mol %, 0.5 mol %, 0.6 mol %, 0.7 mol %, 0.8 mol %, 0.9 mol %, 1.0 mol %, 1.1 mol %, 1.2 mol %, 1.3 mol %, 1.4 mol %, 1.5 mol %, 1.6 mol %, 1.7 mol %, 1.8 mol %, 1.9 mol %, 2.0 mol %, 2.1 mol %, 2.2 mol %, 2.3 mol %, 2.4 mol %, 2.5 mol %, 2.6 mol %, 2.7 mol %, 2.8 mol %, 2.9 mol %, 3.0 mol %, 3.5 mol %, 4.0 mol %, 4.5 mol %, 5.0 mol %, 5.5 mol %, 6.0 mol %, 6.5 mol %, 7.0 mol %, 7.5 mol %, 8.0 mol %, 8.5 mol %, 9.0 mol %, 9.5 mol % or 10.0 mol %; or 0.1 to 10.0 mol %, 0.2 to 10.0 mol %, 0.3 to 10.0 mol %, 0.4 to 10.0 mol %, 0.5 to 10.0 mol %, 0.6 to 10.0 mol %, 0.7 to 10.0 mol %, 0.8 to 10.0 mol %, 0.9 to 10.0 mol %, 1.0 to 10.0 mol %, 1.1 to 10.0 mol %, 1.2 to 10.0 mol %, 1.3 to 10.0 mol %, 1.4 to 10.0 mol %, 1.5 to 10.0 mol %, 1.6 to 10.0 mol %, 1.7 to 10.0 mol %, 1.8 to 10.0 mol %, 1.9 to 10.0 mol %, 2.0 to 10.0 mol %, 2.1 to 10.0 mol %, 2.2 to 10.0 mol %, 2.3 to 10.0 mol %, 2.4 to 10.0 mol %, 2.5 to 10.0 mol %, 2.6 to 10.0 mol %, 2.7 to 10.0 mol %, 2.8 to 10.0 mol %, 2.9 to 10.0 mol %, 3.0 to 10.0 mol %, 3.5 to 10.0 mol %, 4.0 to 10.0 mol %, 4.5 to 10.0 mol %, 5.0 to 10.0 mol %, 5.5 to 10.0 mol %, 6.0 to 10.0 mol %, 6.5 to 10.0 mol %, 7.0 to 10.0 mol %, 7.5 to 10.0 mol %, 8.0 to 10.0 mol %, 8.5 to 10.0 mol %, 9.0 to 10.0 mol % or 9.5 to 10.0 mol %; or 0.1 to 9.9 mol %, 0.1 to 9.8 mol %, 0.1 to 9.7 mol %, 0.1 to 9.6 mol %, 0.1 to 9.5 mol %, 0.1 to 9.4 mol %, 0.1 to 9.3 mol %, 0.1 to 9.2 mol %, 0.1 to 9.1 mol %, 0.1 to 9.0 mol %, 0.1 to 8.9 mol %, 0.1 to 8.8 mol %, 0.1 to 8.7 mol %, 0.1 to 8.6 mol %, 0.1 to 8.5 mol %, 0.1 to 8.4 mol %, 0.1 to 8.3 mol %, 0.1 to 8.2 mol %, 0.1 to 8.1 mol %, 0.1 to 8.0 mol %, 0.1 to 7.9 mol %, 0.1 to 7.8 mol %, 0.1 to 7.7 mol %, 0.1 to 7.6 mol %, 0.1 to 7.5 mol %, 0.1 to 7.4 mol %, 0.1 to 7.3 mol %, 0.1 to 7.2 mol %, 0.1 to 7.1 mol %, 0.1 to 10.0 mol %, 0.1 to 7.0 mol %, 0.1 to 6.5 mol %, 0.1 to 6.0 mol %, 0.1 to 5.5 mol %, 0.1 to 5.0 mol %, 0.1 to 4.5 mol %, 0.1 to 4.0 mol %, 0.1 to 3.5 mol %, 0.1 to 3.0 mol %, 0.1 to 2.5 mol %, 0.1 to 2.0 mol %, 0.1 to 1.5 mol %, 0.1 to 1.0 mol %, 0.1 to 0.5 mol %. In preferred embodiments of the present invention, the modifying monomer of the polyester composition is more preferably present in an amount of 0.5 to 7.5 mol % based on the total amount of polybasic acids or diols of the polyester.

In preferred embodiments of the present invention, the polybasic acids for producing the polyester composition of the present invention may be aliphatic dicarboxylic acids, aromatic dicarboxylic acids, polyfunctional carboxylic acids or precursors for esterification thereof. For example, the aliphatic dicarboxylic acids include but not limited to succinic acid, glutaric acid, adipic acid, pimelic acid, suberic acid, azelaic acid, sebacic acid, 1,4-cyclohexanedicarboxylic acid or precursors for esterification of the aforementioned aliphatic dicarboxylic acids. The aromatic dicarboxylic acids include but not limited to terephthalic acid, isophthalic acid, 2,6-naphthalenedicarboxylic acid or precursors for esterification of the aforementioned aromatic dicarboxylic acids. In addition, the polyfunctional carboxylic acids include but not limited to 1,2,4-benzenetricarboxylic acid, 1,2,4,5-pyromellitic acid or precursors for esterification of 1,2,4-benzenetricarboxylic acid, 1,2,4,5-pyromellitic acid.

In preferred embodiments of the present invention, the diols for producing the polyester of the present invention may be aliphatic diols or precursors for esterification thereof. For example, aliphatic diols include but not limited to ethylene glycol, diethylene glycol, 1,3 propylene glycol, 1,4-butanediol, neopentyl glycol, 1,4-cyclohexanedimethanol or precursors for esterification of the aforementioned aliphatic diols. In addition, the aliphatic diols may also be polyethylene glycol or polytetramethylene ether glycol having molecular weights ranging from about 150 to about 20,000 g/mol or precursors for esterification thereof.

In preferred embodiments of the present invention, the polyester composition of the present invention has a structural formula (V):

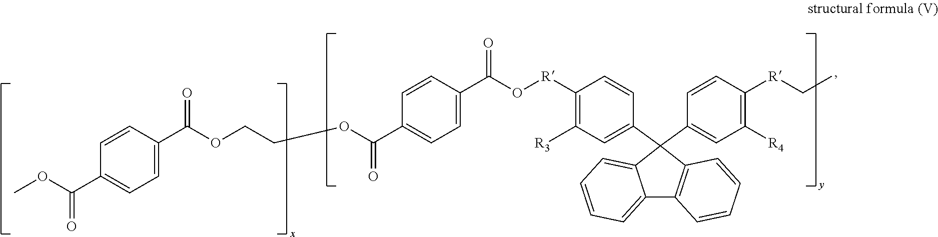

wherein R′ is O, NH or OC₂H₄, and x+y=1, x=0.9 to 0.999, y=0.001 to 0.1.

The polyester composition of the present invention, the process for producing it and various properties thereof (including but not limited to thermal and/or optical properties, etc.) are detailed in the following examples. For instance, the polyester composition of the present invention is preferably formed by a polymerization process. The process is that polybasic acids, diols and modifying monomers are esterified to form esters with low molecular weight with or without addition of catalysts or additives, and then esters with high molecular weight are obtained therefrom by liquid-phase polymerization reaction.

### Polyester Sheet

Another embodiment of the present invention provides a polyester sheet comprising the polyester composition shown in the aforementioned embodiment, for example, is made from said polyester composition, and the detailed production method will be described later. In preferred embodiments, the thickness of the polyester sheet is preferably 200 to 800 μm.

### Polyester Film And the Production Method thereof

Another embodiment of the present invention provides a polyester film comprising the polyester composition in shown in the aforementioned embodiment, which is made from the polyester sheet, and the detailed production method will be described later. The polyester film has an excellent bending resistance and optical properties, which is capable of being bent many times over a long period of time without causing bending marks, and thus it can maintain the clarity of the user's view.

Another embodiment of the present invention provides a process for producing polyester film, of which the steps comprise: 1) extruding said polyester composition into the polyester sheet at a temperature ranging from about 230 to about 300° C., 2) manufacturing the polyester sheet into the polyester film through biaxial drawing, 3) coating a hard coating on the surface of the polyester film. In an embodiment of the present invention, said biaxial drawing is to extend the polyester sheet 1.5-fold to 5-fold in length along a short-axis direction and a long-axis direction of the polyester sheet, wherein the short-axis direction and the long-axis direction are substantially perpendicular to each other.

For example, the polyester composition shown in the foregoing embodiment will be melt and extruded into a polyester sheet and then biaxially drawn to form a polyester film through the process for producing a polyester film. The polyester film produced by this process has excellent bending resistance and optical properties, and the polyester film may be subjected to a hard coating process, or not to a hard coating process, based on the actual application requirements.

In order to make the present invention easier to understand, the esterification reaction, the polymerization catalyst or additives used in the process, the liquid-phase polymerization reaction, process for producing polyester film and hard coating process in the foregoing embodiments will be further described below.

### Esterification Reaction

The term “esterification” used herein mainly refers to the esterification reaction between the reactive functional groups of carboxylic acid or the esterification precursor thereof and the reactive functional groups of alcohol or the esterification precursor thereof.

Specifically, 1 mole of carboxylic acid or the precursor for esterification thereof is added to 1-1.4 mol of alcohol or the precursor for esterification thereof to produce a slurry after mixing, and the slurry is used as the reactant in the esterification reaction to conduct continuous dehydration esterification. The esterification reaction can be conducted in one or more reactors linked to a fractional column at a reaction temperature of about 225 to about 255° C. and under a pressure of about 380 to about 2000 torr or under an atmospheric environment, preferably a nitrogen atmospheric environment. The water removed during the esterification reaction may be collected at the upper end of the fractional column, while the alcohols or the precursors for esterification thereof involved in the reaction are condensed in the fractional column and refluxed back to the reactor. Eventually, esters with molecular weights of about 200 to about 5000 are formed. This esterification reaction can be performed without addition of further catalysts or additives. However, it is also possible to add further catalysts or additives to improve the esterification reaction. The esters with low molecular weight resulted from in the esterification reaction can be subsequently used as a reactant in the liquid-phase polymerization reaction.

### Polymerization Catalyst

In order to increase the liquid-phase polymerization rates, enhance production capacity and improve product quality, polymerization catalysts may be added at the liquid-phase polymerization stage. Polymerization catalysts are mainly metal catalysts, including but not limited to antimony and its oxides, organic salts, acetate salts; tin and its organic salts; titanium and its organic salts; germanium and its oxides or organic salts, etc.

### Additives

Without prejudice to the effects described in the technology of the invention, it is also possible to add commercially available additives to the polyesters of the present invention according to the actual use requirements. The additives may be selected from, for example, heat stabilizer, antioxidant, UV absorber or IR absorber, etc.

### Liquid-Phase Polymerization Reaction

The polymerization catalyst described above is added to the liquid-phase polymerization reaction described herein, and the precursor resulted from the esterification reaction is heated and depressurized to give a product with high molecular weight. During the liquid-phase polymerization process, the excess reactant and by-product will be removed.

The liquid-phase polymerization reaction may be conducted in one or multiple reactors. For example, in the case of one reactor, the liquid-phase polymerization reaction is conducted at a reaction temperature of about 250 to about 290° C. and under a vacuum environment, wherein a pressure is reduced to about 0.01 to about 0.5 torr, with stirring in the presence of a polymerization catalyst.

In the case of reaction in two reactors, the first stage of the liquid-phase polymerization reaction may be conducted at a temperature of about 250 to about 290° C. under a pressure reduced to about 0.5 to about 150 torr. After the reaction reaches constant for a certain period of time, the reactants are transferred into the second stage, wherein the polymerization reaction is completed at a temperature of about 250 to about 290° C. under a pressure reduced to about 0.01 to about 0.5 torr.

In the case of reaction in multiple reactors, the process of the polymerization reaction may be divided into multiple steps according to the requirements. The steps are performed until the final step in the last reactor in which the polymerization reaction is completed at the reaction temperature is about 250 to about 290° C. under a vacuum environment, wherein the pressure is reduced to of about 0.01 to about 0.5 torr.

### Process for Producing Polyester Film

In the following examples, all samples are made to form films with the same thickness for the comparison of the examples. However, this does not mean that the technique of the invention can be only applied to films with this thickness.

The main steps of the process for producing a polyester film comprise melt extruding the polyester pellets from the different examples above through a single screw extruder at a processing temperature of Tm+25° C., and then cooling the melt by a cooling roll to produce a sheet with a thickness of 450 to 500 μm. After each sheet is heated at a temperature of Tg+20° C. for 30 seconds, biaxial drawing to 3× in TD direction and in MD direction, respectively, is conducted to produce a film with a thickness of 50 μm.

### Hard Coating Process

Depending on different final applications of a film, it is sometimes necessary to apply a hard coating on the film. Due to different applications, the hard coatings may have different performance in its characteristics and physical properties. The examples provided herein merely use two different hard coatings for illustration. However, the applications of the present invention are not limited to the listed applications or the coating mentioned herein. Regardless of the application, the hard coatings used preferably meet the specifications requirements of transmittance ≥90%, haze ≤2%, hardness >1H (1 kgf) or >3H (500 gf).

Some examples are provided below to illustrate the core technology of the present invention. However, the technology of the present invention is not limited to the examples provided herein. The examples provided herein are merely used to illustrate the present invention. The technology of the present invention can be extended and applied to similar products with the same concept. Although any process and materials similar or equivalent to those described herein may be used in the practice or experiment of the embodiments and/or examples of the present invention, the preferred process and materials are described herein. All documents mentioned herein are incorporated by reference in their entirety.

### EXAMPLES

### Comparative Example 1

34.6 kg of terephthalic acid and 14.2 kg of ethylene glycol were added to a reaction tank, which was heated to 245° C. with stiffing to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV (Intrinsic viscosity)=0.62 dl/g, the cooled product was taken out from the reaction tank for pelletization to produce polyester pellets.

The polyester pellets have a melting point (Tm) of about 252° C. and a glass transition temperature (Tg) of about 79.3° C.

### Example 1

33.6 kg of terephthalic acid, 13.6 kg of ethylene glycol and 1.3 kg of BPEF were added into the reaction tank, which was heated to 245° C. with stiffing to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 248.1° C. and a glass transition temperature of about 83.1° C.

### Example 2

32.6 kg of terephthalic acid, 13.2 kg of ethylene glycol and 2.2 kg of BPEF were added into the reaction tank, which was heated to 245° C. with stiffing to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 245.9° C. and a glass transition temperature of about 85.7° C.

### Example 3

31.5 kg of terephthalic acid, 12.4 kg of ethylene glycol and 4.2 kg of BPEF were added into the reaction tank, which was heated to 245° C. with stiffing to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 239.6° C. and a glass transition temperature of about 90.4° C.

### Example 4

33.8 kg of terephthalic acid, 13.7 kg of ethylene glycol and 1.1 kg of BPF were added into the reaction tank, which was heated to 245° C. with stiffing to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 247.9° C. and a glass transition temperature of about 82.8° C.

### Example 5

33.2 kg of terephthalic acid, 13.3 kg of ethylene glycol and 1.8 kg of BPF were added into the reaction tank, which was heated to 245° C. with stiffing to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 245.6° C. and a glass transition temperature of about 84.8° C.

### Example 6

33.7 kg of terephthalic acid, 13.7 kg of ethylene glycol and 1.2 kg of BCF were added into the reaction tank, which was heated to 245° C. with stiffing to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 248.2° C. and a glass transition temperature of about 82.4° C.

### Example 7

33.2 kg of terephthalic acid, 13.3 kg of ethylene glycol and 1.9 kg of BCF were added into the reaction tank, which was heated to 245° C. with stirring to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 246.9° C. and a glass transition temperature of about 85.1° C.

### Example 8

33.8 kg of terephthalic acid, 13.7 kg of ethylene glycol and 1.1 kg of BAF were added into the reaction tank, which was heated to 245° C. with stirring to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 248.4° C. and a glass transition temperature of about 82.3° C.

### Example 9

33.3 kg of terephthalic acid, 13.4 kg of ethylene glycol and 1.7 kg of BAF were added into the reaction tank, which was heated to 245° C. with stiffing to carry out the esterification reaction. After the esterification reaction is completed, 24 g of magnesium acetate, 15.6 g of triethyl phosphonoacetate, and 13.2 g of antimony trioxide were added, and the mixture was evacuated from 760 torr to 0.1 torr in 30 minutes, and continuously stirred to carry out the polymerization reaction. After the polymerization reaction reached IV=0.62 dl/g, the cooled product was taken out from the reaction tank for pelletization to produce polyester pellets. The polyester pellets have a melting point of about 245.2° C. and a glass transition temperature of about 84.6° C.

The properties and constituents of the polyesters produced from different formulations as stated above are shown in the Table 1:

TABLE 1
Comparison of the properties of the polyesters with different formulations

| | Alcohol | Glass Transition | | | | |
|---|---|---|---|---|---|---|
| | Modification | Temperature | Melting Point | | | |
| | (mol %) | Tg (° C.) | Tm (° C.) | L | a | b |
| Comparative | — | 79.3 | 252 | 64.4 | −1.1 | 2 |
| Example 1 | | | | | | |
| Example 1 | BPEF 1.5 | 83.1 | 248.1 | 64.6 | −1.1 | 2.1 |
| Example 2 | BPEF 2.5 | 85.7 | 245.9 | 64.5 | −1.2 | 2.4 |
| Example 3 | BPEF 5 | 90.4 | 239.6 | 64.1 | −1.9 | 4.2 |
| Example 4 | BPF 1.5 | 82.8 | 247.9 | 64.3 | −1.2 | 2.3 |
| Example 5 | BPF 2.5 | 84.8 | 245.6 | 64.1 | −1.3 | 2.6 |
| Example 6 | BCF 1.5 | 82.4 | 248.2 | 64.3 | −1.3 | 2.2 |
| Example 7 | BCF 2.5 | 85.1 | 246.9 | 64.2 | −1.5 | 2.5 |
| Example 8 | BAF 1.5 | 82.3 | 248.4 | 64.2 | −1.2 | 2.4 |
| Example 9 | BAF 2.5 | 84.6 | 245.2 | 63.9 | −1.3 | 2.6 |

It is found that as the amount of BPEF increases, the glass transition temperature also increases. This may cause the increase of energy consumption in the subsequent drawing process, meanwhile, the decrease of the melting point, resulting in that the polyester gradually changes to amorphous polyester, which may lead to poor dimensional stability of the processed products. In the meantime, as the amount of BPEF increases, the b value of the CIELAB color space also increases slightly, which means that the color of the polyester becomes slightly yellowish as the addition amount increases, but the polyester still meets the transparency requirements of optical films. The thermal properties of the polyester with the addition of similar amount of modifying monomers, BPF, BCF or BAF, are similar to the polyester with the addition of BPEF.

### Comparative Example 2

The polyester pellets of Comparative Example 1 were used to produce a film according to the process for producing polyester film as stated above, and then SilFORT 7800G of Momentive Performance Materials Inc. was coated on the surface of the film. After UV curing, a hardened coating layer was formed on the surface, and the coating layer has transmittance ≥90%, haze ≤2%, and hardness >1H (1 kgf).

### Comparative Example 3

The polyester pellets of Comparative Example 1 were used to produce a film according to the process for producing polyester film as stated above, and then KCF-5501A of SEIKO PMC Corporation was coated on the surface of the film. After UV curing, a hardened coating layer was formed on the surface, and the coating layer has transmittance ≥90%, haze ≤2%, and hardness >3H (500 gf).

### Example 10

The polyester pellets of Example 1 were used to produce the film according to the process for producing polyester film as stated above, and then SilFORT 7800G of Momentive Performance Materials Inc. was coated on the surface of the film. After UV curing, a hardened coating layer was formed, and the coating layer has transmittance ≥90%, haze ≤2%, and hardness >1H (1 kgf).

### Example 11

The polyester pellets of Example 1 were used to produce a film according to the process for producing polyester film as stated above, and then KCF-5501A of SEIKO PMC Corporation was coated on the surface of the film. After UV curing, a hardened coating layer was formed on the surface, and the coating layer has transmittance ≥90%, haze ≤2%, and hardness >3H (500 gf).

### Example 12

The polyester pellets of Example 2 were used to produce the film according to the process for producing polyester film as stated above, and then SilFORT 7800G of Momentive Performance Materials Inc. was coated on the surface of the film. After UV curing, a hardened coating layer was formed, and the coating layer has transmittance ≥90%, haze ≤2%, and hardness >1H (1 kgf).

### Example 13

The polyester pellets of Example 2 were used to produce a film according to the process for producing polyester film as stated above, and then KCF-5501A of SEIKO PMC Corporation was coated on the surface of the film. After UV curing, a hardened coating layer was formed on the surface, and the coating layer has transmittance ≥90%, haze ≤2%, and hardness >3H (500 gf).

### Example 14

The polyester pellets of Example 5 were used to produce the film according to the process for producing polyester film as stated above, and then SilFORT 7800G of Momentive Performance Materials Inc. was coated on the surface of the film. After UV curing, a hardened coating layer was formed, and the coating layer has transmittance ≥90%, haze ≤2%, and hardness >1H (1 kgf).

### Example 15

The polyester pellets of Example 7 were used to produce the film according to the process for producing polyester film as stated above, and then SilFORT 7800G of Momentive Performance Materials Inc. was coated on the surface of the film. After UV curing, a hardened coating layer was formed, and the coating layer has transmittance ≥90%, haze ≤2%, and hardness >1H (1 kgf).

### Example 16

The polyester pellets of Example 9 were used to produce the film according to the process for producing polyester film as stated above, and then SilFORT 7800G of Momentive Performance Materials Inc. was coated on the surface of the film. After UV curing, a hardened coating layer was formed, and the coating layer has transmittance ≥90%, haze ≤2%, and hardness >1H (1 kgf).

The condition of the bending resistance test are to test the polyester film for 100,000 to 300,000 bending times with a bending radius of 0.5 to 6 mm at a frequency of 1 time per second and observe whether there are cracks or bending marks. The specific steps of the bending resistance test are: firstly, cutting the bending-resistant polyester film into samples with a width of 2 cm and a length greater than 15 cm, and fixing the film with clamps on both sides. The interval between the clamps is 10 cm. The clamps can be move horizontally and installed on a fixed track mechanism. One side of the clamps is fixed and immovable, and the other side of the clamps can move back and forth. When the bending resistance test starts, the two clamps turn from horizontal to vertical automatically and move horizontally from the reciprocating side to the fixed side at the same time, and finally the interval between the two clamps is 0.5 to 6 mm. Meanwhile, the bending radius of the polyester film is 0.5 to 6 mm and the clamp moves back and forth at a frequency of 1 time per second. This condition is repeated 100,000 to 300,000 times. The test results are observed with the naked eye and under microscope to see if there are any bending marks, and the results are shown in Table 2. If there are no bending marks observed with the naked eye and no bending marked observed under microscope on the polyester film, the test results are marked with “Δ” in Table 2. If there are no bending marks observed with the naked eye but very slight bending marks observed under microscope on the polyester film, the test results are marked with “○” in Table 2. If there is presence of bending marks observed with the naked eye on the polyester film, the test results are marked with “X” in Table 2.

TABLE 2
Results of bending the sheets for 200,000
times with a bending radius of 1 mm

| | | Result | | Result |
|---|---|---|---|---|
| | Alcohol | of the | | of the |
| | Modification | Bending | | Bending |
| | (mol %) | Test | Hard Coating | Test |
| Comparative | — | X | (Comparative | X |
| Example 1 | | | Example 2) | |
| | | | SilFORT 7800G | |
| | | | (Comparative | X |
| | | | Example 3) | |
| | | | KCF-5501A | |
| Example 1 | BPEF 1.5 | Δ | (Example 10) | Δ |
| | | | SilFORT 7800G | |
| | | | (Example 11) | Δ |
| | | | KCF-5501A | |
| Example 2 | BPEF 2.5 | ◯ | (Example 12) | ◯ |
| | | | SilFORT 7800G | |
| | | | (Example 13) | ◯ |
| | | | KCF-5501A | |
| Example 3 | BPEF 5 | ◯ | — | — |
| Example 4 | BPF 1.5 | Δ | — | — |
| Example 5 | BPF 2.5 | ◯ | (Example 14) | ◯ |
| | | | SilFORT 7800G | |
| Example 6 | BCF 1.5 | Δ | — | — |
| Example 7 | BCF 2.5 | ◯ | (Example 15) | ◯ |
| | | | SilFORT 7800G | |
| Example 8 | BAF 1.5 | Δ | — | — |
| Example 9 | BAF 2.5 | ◯ | (Example 16) | ◯ |
| | | | SilFORT 7800G | |

From the results of Table 2, it can be seen that as the proportion of the bending-resistant modifying monomer increases, the processed product film has better bending resistance. When the proportion of the bending-resistant modifying monomer reaches a certain level, the bending resistance can meet the requirement of 200,000 bending times with a bending radius of 1 mm.

The thermal shrinkage rate and the dimensional stability of the films were determined according to the standard test method of ASTM D1204, and the results are shown in Table 3. Regarding the thermal shrinkage rate of the films, if the thermal shrinkage rate in machine direction (MD) is less than 0.8%, or the thermal shrinkage rate in transverse direction (TD) is less than 0.4%, it means that the films has a better application effect, which is marked with “○” as the test result of Example 1 in Table 3. As the proportion of modifying monomer in the film increases, the crystallization property of the polyester also changes, which also affect the thermal shrinkage rate of the film simultaneously. As the proportion of modifying monomer in the film increases, the heat shrinkage rate also increases. If the thermal shrinkage rate in machine direction (MD) is between 0.8% and 1.0%, or the thermal shrinkage rate in transverse direction (TD) is between 0.4% and 0.5%, it means that the films is less favorable for applications, which is marked with “Δ” as the test result of Example 3 in Table 3. Regarding Corners Warpage, if the warpage of the four corners is less than 1.5 mm, it means the films have a better dimensional stability, which is marked with “○” as the test result of Example 1 in Table 3. If the warpage of the four corners is between 15 mm and 2mm, it means the films has a less favorable dimensional stability, which is marked with “Δ” as the test result of Example 3 in Table 3. Based on the results in Table 3, the dimensional stability of the films having higher proportion of modifying monomer is unreliable.

TABLE 3
Comparison of heat thermal and dimensional
stability of the final films

| | | | Td | Md | |
|---|---|---|---|---|---|
| | Alcohol | | Thermal | Thermal | |
| | Modification | Hard | Shrink- | Shrink- | Dimensional |
| | (mol %) | Coating | age | age | Stability |
| Comparative | — | — | ∘ | ∘ | ∘ |
| Example 1 | | | | | |
| Example 1 | BPEF 1.5 | — | ∘ | ∘ | ∘ |
| Example 2 | BPEF 2.5 | — | ∘ | ∘ | ∘ |
| Example 3 | BPEF 5 | — | Δ | Δ | Δ |
| Example 4 | BPF 1.5 | — | ∘ | ∘ | ∘ |
| Example 5 | BPF 2.5 | — | ∘ | ∘ | ∘ |
| Example 6 | BCF 1.5 | — | ∘ | ∘ | ∘ |
| Example 7 | BCF 2.5 | — | ∘ | ∘ | ∘ |
| Example 8 | BAF 1.5 | — | ∘ | ∘ | ∘ |
| Example 9 | BAF 2.5 | — | ∘ | ∘ | ∘ |
| Comparative | — | SilFORT | ∘ | ∘ | ∘ |
| Example 2 | | 7800G | | | |
| Comparative | — | KCF- | ∘ | ∘ | ∘ |
| Example 3 | | 5501A | | | |
| Example 10 | BPEF 1.5 | KCF- | ∘ | ∘ | ∘ |
| | | 5501A | | | |
| Example 11 | BPEF 1.5 | SilFORT | ∘ | ∘ | ∘ |
| | | 7800G | | | |
| Example 12 | BPEF 2.5 | SilFORT | ∘ | ∘ | ∘ |
| | | 7800G | | | |
| Example 13 | BPEF 2.5 | KCF- | ∘ | ∘ | ∘ |
| | | 5501A | | | |
| Example 14 | BPF 2.5 | SilFORT | ∘ | ∘ | ∘ |
| | | 7800G | | | |
| Example 15 | BCF 2.5 | SilFORT | ∘ | ∘ | ∘ |
| | | 7800G | | | |
| Example 16 | BAF 2.5 | SilFORT | ∘ | ∘ | ∘ |
| | | 7800G | | | |

1. A polyester composition, which comprises repeating monomers including at least one polybasic acid and at least one diol, and comprises at least one modifying monomer having the following general formula (1), 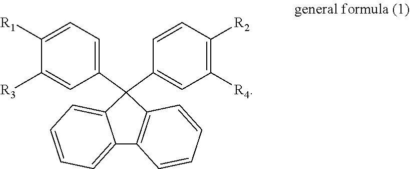
wherein
R₁ and R₂ are independently an amino group, hydroxyl group or hydroxyl C₁₋₈ alkoxy group; and
R₃ and R₄ are independently a hydrogen atom or a C₁₋₈ alkyl group.

2. The polyester composition according to claim 1, wherein the hydroxyl C₁₋₈ alkoxy group is a hydroxyethoxy group.

3. The polyester composition according to claim 1, wherein the C₁₋₈ alkyl group is a methyl group or an ethyl group.

4. The polyester composition according to claim 1, of which a glass transition temperature is from 75 to 95° C. and a melting point is from 230 to 255° C.

5. The polyester composition according to claim 1, wherein the modifying monomer comprises 9,9-Bis[4-(2-hydroxyethoxy)phenyl]fluorene (BPEF), 9,9-bis(4-hydroxyphenyl)fluorene (BPF), 9,9-Bis(4-hydroxy-3-methylphenyl)fluorene (BCF), 9,9-Bis(4-aminophenyl)fluorene (BAF) or a precursor for esterification thereof.

6. The polyester composition according to claim 1, wherein a proportion of the modifying monomer is 0.1 to 10 mol % based on the total amount of the polybasic acids or the diols.

7. The polyester composition according to claim 1, wherein the polybasic acid comprises an aliphatic dicarboxylic acid, an aromatic dicarboxylic acid, a polyfunctional carboxylic acid or a precursor for esterification thereof.

8. The polyester composition according to claim 7, wherein the aliphatic dicarboxylic acid comprises a succinic acid, a glutaric acid, an adipic acid, a pimelic acid, a suberic acid, an azelaic acid, a sebacic acid, or a 1,4-cyclohexanedicarboxylic acid.

9. The polyester composition according to claim 7, wherein the aromatic dicarboxylic acid comprises a terephthalic acid, an isophthalic acid, or a 2,6-naphthalenedicarboxylic acid.

10. The polyester composition according to claim 7, wherein the polyfunctional carboxylic acid comprises 1,2,4-benzenetricarboxylic acid or 1,2,4,5-pyromellitic acid.

11. The polyester composition according to claim 1, wherein the diol comprises an aliphatic diol or a precursor for esterification of the aliphatic diol.

12. The polyester composition according to claim 11, wherein the aliphatic diol comprises an ethylene glycol, a diethylene glycol, a 1,3 propylene glycol, a 1,4-butanediol, a neopentyl glycol, a 1,4-cyclohexanedimethanol.

13. The polyester composition according to claim 11, wherein the aliphatic diol comprises a polyethylene glycol or a polytetramethylene ether glycol having molecular weights ranging from about 150 to about 20,000 g/mol.

14. The polyester composition according to claim 1, wherein the polyester composition has a structural formula (V), 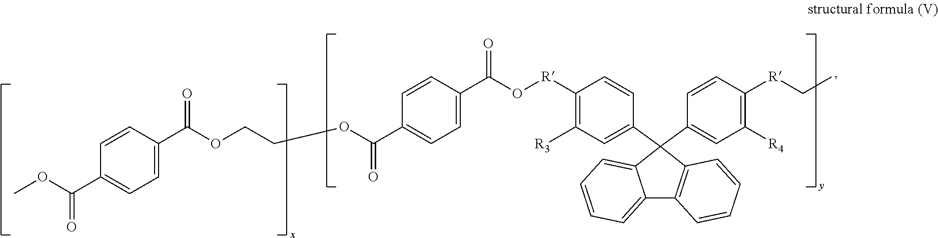
wherein
R′ is O, NH or OC₂H₄, and x+y=1, x=0.9 to 0.999, y=0.001 to 0.1.

15. A polyester sheet, which comprises the polyester composition according to claim 1.

16. The polyester sheet according to claim 15, of which thickness is 200 to 800 μm.

17. A polyester film, which comprises the polyester composition according to claim 1.

18. The polyester film according to claim 17, of which thickness is 20 to 200 μm.

19. The polyester film according to claim 17, which further comprises a hard coating on a surface of the polyester film, wherein the hard coating has a transmittance equal or more than 90%, a haze equal or less than 2% and a hardness more than 1H (1 kg load) measured in accordance with ASTM D1003.

20. A process for producing a polyester film, which comprise: 1) extruding the polyester composition according to claims 1 into a polyester sheet at a temperature ranging from about 230 to about 300° C., 2) manufacturing the polyester sheet into a polyester film through biaxial drawing, 3) coating a hard coating on the surface of the polyester film.

21. The process according to claim 20, wherein the biaxial drawing is to extend the polyester sheet 1.5-fold to 5-fold in length along both of a short-axis direction and a long-axis direction of the polyester sheet, wherein the short-axis direction and the long-axis direction are substantially perpendicular to each other.
